(19) United States
(12) Patent Application Publication
(10) Pub. No.: US 2004/0091072 A1
(43) Pub. Date: May 13, 2004

(54) Initial synchronization searching in mobile communication systems

(75) Inventor: Jae-Cheol Lee, Seoul (KR)

Correspondence Address: FLESHNER & KIM, LLP, P.O. BOX 221200, CHANTILLY, VA, 20153, US

(73) Assignee: LG ELECTRONICS INC.

(21) Appl. No.: 10/696,997

(22) Filed: Oct. 31, 2003

(30) Foreign Application Priority Data
Nov. 2, 2002 (KR) 67669/2002

(51) Int. Cl. H04L 7/00

(52) U.S. Cl. 375/354

(57) ABSTRACT

An initial synchronization searching apparatus and method in a mobile communication system are disclosed. Correlation is not performed an entire input signal but on a specific region of an input signal. Accordingly, complicate calculations required for the initial synchronization of the TD-SCDMA or the UMTS-TDD terminal can be considerably reduced. The initial synchronization searching method includes: accumulating input signals for several frames; taking an absolute value of the accumulated value; and searching a region with a high power distribution having a certain length from the absolute-taken signal, selecting it as a candidate region and searching for synchronization in the selected candidate region.

### BACKGROUND OF THE INVENTION

1. Field of the Invention

The present invention relates to a mobile communication system and, more particularly, to an initial synchronization searching apparatus and method in a TD-SCDMA (Time Division-Synchronous Code Division Multiple Access) system.

2. Background of the Related Art

In general, a Time Division-Synchronous Code Division Multiple Access (MD-SCDMA) communication system is a communication system combining a Narrow Band Time Division Duplexing (NB-TDD) CDMA communication system and a Global System for Mobile Communications GSM system. In the TD-SCDMA communication system, a radio interface, a first layer (Layer 1) between a terminal and a base station is the same as the NB-TDD CDMA system and the other upper layers have the same structure as the GSM system.

Usually, an initial cell searching process of the TD-SCDMA communication system is divided into four steps. The first step is to receive base station information of a cell to which a terminal belongs currently. The second step is to identify a scrambling code and a basic midamble code being used. The third step is to check a position of a broadcast control channel (BCCH). The fourth step is to access information on a common channel including information, that is, system information, transferred through the BCCH.

In the step of receiving the base station information, the terminal searches a downlink pilot time slot (DwPTS) and obtains a downlink synchronization with the base station. For this purpose, the terminal selects one synchronous code from 32 synchronous codes (pilot signals) defined in standards and correlates the selected synchronous code with a baseband input signal (referred to as ‘input signal’, hereinafter). In this manner, the terminal sequentially correlates 32 synchronous codes with an input signal to search the most similar synchronous code to a DwPTS that the base station has transferred, thereby performing an initial synchronization with the base station.

For the initial synchronization with the base station, the terminal may use at least one or more matching filter. That is, in order to obtain the initial synchronization, the terminal performs correlation by using a 64 tap finite impulse response (FIR) filter corresponding to the length of the DwPTS.

In this respect, however, when the base station selects one of the 32 pilot signals (DwPTS) and transfers it to the terminal, the terminal can not be aware of which DwPTS the base station has transferred. Thus, one fastest way the terminal searches the initial synchronization can be to perform a correlation by using the 32 64 tap FIR filters, but, in this case, a hardware of the terminal is complicated in its construction.

In addition, in the case of searching the initial synchronization by using the one FIR filter, though the hardware construction may be simple, 32 times of correlation should be performed for the initial synchronization, causing a problem that it takes a long time for searching. Meanwhile, the fact that the filter tap is long when performing the correlation for the initial synchronization searching in the terminal means the terminal should repeatedly perform numerous multiplications and additions

In other words, for obtaining the initial synchronization, a correlator should perform 64 times of multiplications and additions, which is to be performed 32 times for every input signal (I, Q). Thus, unless a calculation speed is faster than a speed of an input signal, a signal of more than 1 sub-frame should be in a memory and then the calculation operation should be repeatedly performed by 32 times. This results in severe power consumption of a system.

### SUMMARY OF THE INVENTION

An object of the invention is to solve at least the above problems and/or disadvantages and to provide at least the advantages described hereinafter.

Therefore, an object of the embodiments of the present invention is to provide an initial synchronization searching apparatus and method

an object of the embodiments of the present invention is to provide a mobile communication system capable of searching an initial synchronization simply and quickly.

An object of the embodiments of the present invention is to provide an initial synchronization searching apparatus and method that reduces complexity.

An object of the embodiments of the present invention is to reduce power consumption of a mobile communication system.

To achieve at least the above objects in whole or in parts, there is provided an initial synchronization searching method of a mobile communication system in which an initial synchronization is performed between a terminal and a base station, including: selecting a region for an initial synchronization from an input signal; and obtaining an initial synchronization by correlating the selected region and a synchronous code. Preferably, the accumulating step is performed by a circulation buffer.

In the initial synchronization method, the region selecting step includes: respectively accumulating input signals of a channel I and a channel Q and obtaining absolute values; adding the two absolute values; and estimating a region showing a remarkable power distribution in a power distribution of the added absolute value as a candidate region. In this case, the candidate region estimating step includes: searching a region with a remarkable power distribution from the absolute value of the input signal; checking whether a length of the corresponding region corresponds to a search range; and estimating the corresponding region as a candidate region if the length of the region with the remarkable power distribution corresponds to the search range. Preferably, the search range is 64 chips.

In the initial synchronization method, the initial synchronization obtaining step includes: obtaining a correlation value of each candidate region; and judging that synchronization has been obtained in a corresponding candidate region if a specific correlation value is greater than a certain threshold value.

To achieve at least these advantages in whole or in parts, there is further provided an initial synchronization method of a mobile communication system including: respectively accumulating signals I and Q and obtaining each absolute value; adding the two absolute values; estimating a candidate region from a power distribution of the added absolute value; and correlating the estimated candidate region with a synchronous code to obtain initial synchronization of a terminal.

The estimating step includes: searching a region with a remarkable power distribution from the absolute value of the 1 frame; checking whether a length of the region with the remarkable power distribution corresponds to the search range; and estimating a corresponding region as a candidate region if the length of the region with the remarkable power distribution corresponds to the search range. Preferably, the search range is 64 chips.

The initial synchronization obtaining step includes: obtaining a correlation value by correlating the candidate region and a synchronous code; and judging that synchronization has been obtained at the corresponding candidate region if the specific correlation value is greater than a certain threshold value.

To achieve at least these advantages in whole or in parts, there is further provided an initial synchronization apparatus of a mobile communication system including: first and second accumulation buffer for respectively accumulating signals I and Q; first and second absolute value calculators for obtaining an absolute value from outputs of the first and second accumulation buffers; an adder for adding outputs of the first and second absolute value calculator; an estimator for estimating a candidate region for initial synchronization from the added absolute value; and a synchronization searching unit for obtaining an initial synchronization of a terminal by correlating the estimated candidate region and a synchronous code. Preferably, the accumulation buffer is a circulation buffer.

Preferably, the estimator searches a region with a remarkable power distribution from an absolute value of 1 frame and estimates a region with a length of a power distribution corresponding to the search range as a candidate region. Preferably, the search range is 64 chips.

Preferably, the synchronization searching unit obtains a correlation value by correlating the candidate region and a synchronous code, and if a specific correlation value is greater than a certain threshold value, the synchronization searching unit judges that a synchronization has been obtained in the corresponding candidate region.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates a physical channel structure of a general TD-SCDMA or a UMTS-TDD;

FIG. 2 illustrates an initial synchronization searching apparatus of a mobile communication system in accordance with an embodiment of the present invention;

FIG. 3 is a flow chart of an initial synchronization searching method of a mobile communication system in accordance with an embodiment of the present invention; and

FIGS. 4A and 4B illustrate a method for estimating a candidate region from a power distribution of an input signal.

### DETAILED DESCRIPTION OF PREFERRED EMBODIMENTS

In general, a pilot signal of the TD-SCDMA mode or a Universal Mobile Telecommunications System-Time division Duplexing (UMTS-TDD) mode has a characteristic that it is repeated at a specific position of every sub-frame. In contrast, other signals are expressed as random signals. This is requisite in terms of the CDMA. Accordingly, the pilot signal can be used as a synchronous code (Sync-DL) for an initial synchronization between a terminal and a base station.

32 synchronous codes (Sync-DL) with a length of 64 bits are displayed in 3GPP TS 25.233. The base station selects one of the 32 synchronous codes and repeatedly inserts the selected synchronous code to a specific position of every sub-frame, that is, the DwPTS (Downlink Pilot Time Slot) so that the terminal can use it for an initial synchronization operation.

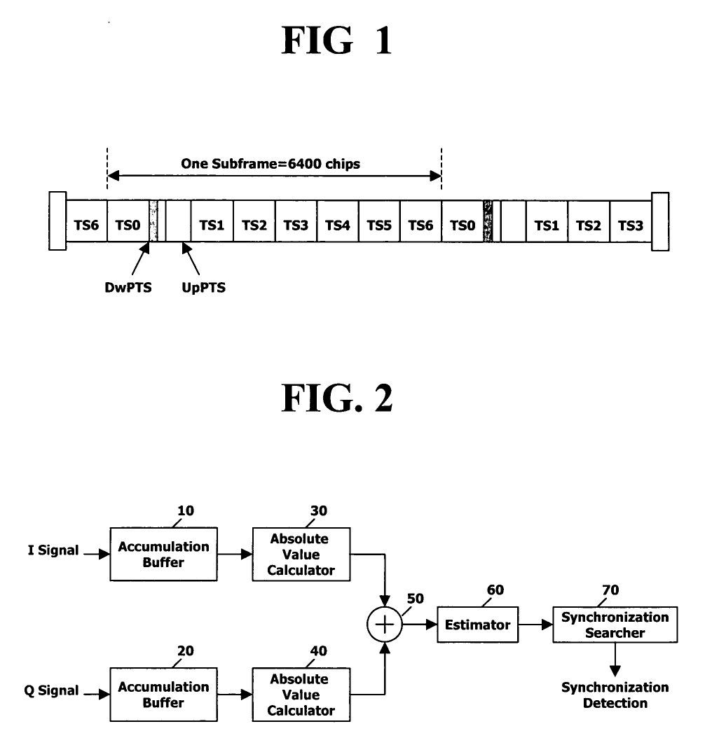

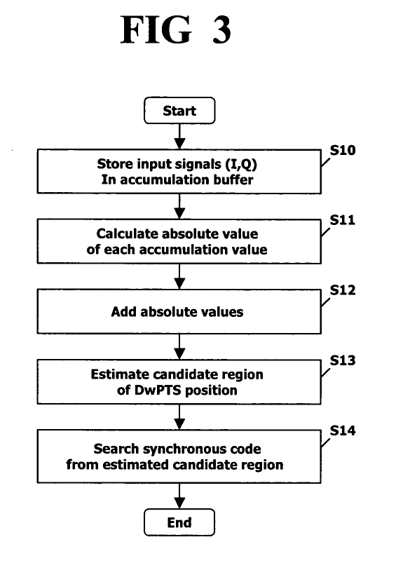

FIG. 1 illustrates a physical channel structure of a TD-SCDMA or a UMTS-TDD. As shown in FIG. 1, the TD-SCDMA physical channel includes a plurality of sub-frames. The shadow regions indicate positions of the DwPTS and the other remaining regions indicate various data and control channels. The other remaining regions may include an uplink pilot time slot (UpPTS) and a noise that a neighboring terminal transfers and signals, which have passed a fading channel.

Accordingly, in the TD-SDMA or UMTS-TDD mode, the terminal correlates an input signal and a synchronous code for an initial synchronization with a base station. In this case, referring back to the conventional art, 32 synchronous codes provided in the terminal are sequentially correlated with the entire input signals to search the most similar synchronous code to DwPTS transferred by the base station, thereby performing an initial synchronization.

In contrast, the present invention proposes a method in which correlation is performed not on the entire input signals but on a specific region of an input signal, so that the initial synchronization of the TD-SCDMA can be proceed simply and quickly. For this purpose, in the present invention, buffers are provided to respectively store input signals I and Q of one sub frame, in which input signals are accumulated for several frames. In this case, only addition is necessary for one sample. When an absolute value of the accumulation values of the input signals stored in the buffers is obtained in a lapse of certain time, average powers of the input signals are shown to be periodic. Thus, assuming that the buffers are the circulation buffers, a signal region having a significant average power exceeding a certain length (e.g., about 60 chips) is searched and selected as a candidate region, and a correlation is performed on the selected candidate region. Those skilled in the art will appreciate the signal region having a significant power can include a relatively high power region when compared to the other regions, or exceeding a threshold or a threshold differential and the like.

Because only addition is performed on the input signals, the overall calculation is very simple. Also, because the candidate region can be estimated very precisely, there typically are not many follow-up calculations. Further, because the processing is not performed in parallel, software and hardware implementation of this process is not complicated.

FIG. 2 illustrates an initial synchronization searching apparatus according to an embodiment of the present invention. The apparatus includes: accumulation buffers 10 and 20 for respectively accumulating input signals I and Q; absolute value calculators 30 and 40 for respectively calculating an absolute value of output values of the accumulation buffers 10 and 20; an adder 50 for adding an absolute value of the absolute value calculators 30 and 40; an estimator 60 for estimating a candidate region for searching a position of a downlink pilot signal (DwPTS) by using the addition value of the adder 50; and a synchronization searching unit 70 for performing a correlation on the candidate region estimated by the estimator 60 and obtaining an initial synchronization.

Input signals I and Q are sampled baseband signals, and each accumulating buffer 10 and 20 typically has the size of 6400 chips. If the input signal is a signal oversampled by ‘m’ times a chip rate of the baseband signal, the size of the accumulation buffers 10 and 20 would be 6400 chips×m, in this example.

Input signals I and Q transmitted by a base station has are accumulated in each accumulation buffer 10 and 20 (step S10). Because the accumulation buffers 10 and 20 are circulation buffers, when input signals I and Q are stored to the last storage region, input signals I and Q are stored by being added to the previously stored values from the first storage region. This can be expressed by the following equation (1):

ΣI(t% L)=ΣQ(t% L) (1)

wherein ‘t’ is an input sequence number, ‘L’, the size of the accumulation buffer, is 6400 chips or 6400 chips×m (in the case of oversampling), % indicates a remaining operator. In this case ‘t’ is an integer from 1 to n, and t% L has a value of 0˜6400. That is, ΣI(t% L) can be expressed by I(1% 6400)+I(2% 6400)+I(3% 6400)+ . . . +I(n% 6400).

Thus, according to a remaining calculation result, a value I(1) is stored in an address 1 of the accumulation buffer 10 and a value I(2) is stored in an address 2. In this manner, a result value of I(0) is stored in an address 6400, and the next inputted I(1) is accumulatively stored in the address 1.

The absolute value calculators 30 and 40 receive the accumulation values of the accumulation buffers 10 and 20 and calculate absolute values (step S11), and the adder 50 adds absolute values outputted from the absolute value calculators 30 and 40 (step S12). The addition result can be expressed by below equation (2):

|ΣI(t% L)|+|ΣO(t% L)| (2)

When addition operation is performed as described above, assuming a noise signal has zero-mean characteristics, and assuming that UpPTSs between time slots (TS0-TS6) and different terminals are uncorrelated in the TD-SCDMA physical channel, the addition value approaches a zero-mean random noise. Then, regions with a relatively high power distribution appear periodically in one sub-frame. In this case, additional connection of a low pass filter (LPF) to an output terminal of the adder 50 helps to obtain a more certain power distribution.

Accordingly, the estimator 60 receives the output value corresponding to the 1 sub-frame (6400 chips) from the adder 50 or from the LPF (in the case that LPF is connected) and estimates a region having a relatively high power distribution as a candidate region of DwPTS (step S13). At this time, a range (W) for estimating the candidate region is preferably 64 chips.

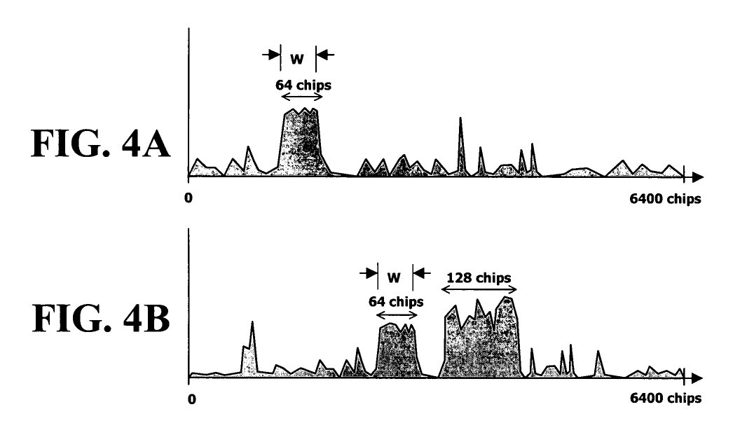

FIGS. 4A and 4B illustrate a method for estimating a candidate region in a power distribution of a signal outputted from the adder 50 or from the LPF. An input signal including only DwPTS of the base station is illustrated in FIG. 4A. A power block similar to the length of 64 chips in the power distribution can be regarded as the position of DwPTS. Accordingly, the estimator 60 estimates the region corresponding to 64 chips as a candidate region of DwPTS.

FIG. 4B illustrates an example having an input signal that includes both DwPTS of the base station and UpPTS of a neighboring terminal, of which the UpPTS shows a greater power distribution than the DwPTS. However, as shown in FIG. 4B, the length of the power distribution of the UpPTS is 128 chips, which exceeds the appropriate search range (W=64 chips). Accordingly, the UpPTS is not included as a candidate region of the DwPTS. That is, estimator 60 regards only a region with a relatively high power distribution and a size of approximately 64 chips appearing in the input signal as a candidate region.

The synchronization searching unit 70 searches for a position of DwPTS from the candidate region(s) estimated by the estimator 60 (step S14). Thus, the synchronization searching unit 70 correlates the estimated regions and the synchronous code and obtains synchronization of the DwPTS. Specifically, the synchronization searching unit 70 performs the correlation on the candidate region(s), and if the correlation value is greater than a certain threshold value as is known in the art. The synchronization searching unit 70 judges the corresponding candidate region as a DwPTS position, thereby obtaining an initial synchronization.

Because correlation is not performed on an entire input signal but on a specific region of an input signal, complicate calculations required for the initial synchronization of the TD-SCDMA or the UMTS-TDD terminal can be considerably reduced. Therefore, the overall search range is reduced as much as W from 6400 or 6400×m, so that the searching time can be shortened.

Further, in order for the terminal to be synchronized with the base station, only addition is performed, instead of multiplication and addition as in the conventional art. Thus, the overall calculation amount for obtaining synchronization is reduced. Accordingly, the complexity and power consumption can be reduced in the communication system.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An synchronization searching method of a mobile communication system, the method comprising:
selecting a region for an initial synchronization from an input signal; and
obtaining a synchronization by correlating the selected region and a synchronous code.

2. The method of claim 1, wherein the region selecting comprises:
respectively accumulating input signals of a channel I and a channel Q and obtaining absolute values for each;
adding the two absolute values; and
estimating a region showing a high power distribution in a power distribution of the added absolute value as a candidate region.

3. The method of claim 2, wherein accumulating is performed by a circulation buffer.

4. The method of claim 2, wherein the candidate region estimating comprises:
searching the region with the high power distribution from the absolute value of the input signal;
checking whether a length of the region corresponds to a search range; and
estimating the region as a candidate region if the length of the region with the high power distribution corresponds to the search range.

5. The method of claim 4, wherein the search range is 64 chips.

6. The method of claim 2, wherein the input signal is accumulated by according to the following equation:
ΣI(t% L)=ΣQ(t% L)
wherein ‘t’ is an input sequence number, ‘L’ is a size of the accumulation buffer, and % indicates a remaining operator.

7. The method of claim 1, wherein the initial synchronization obtaining comprises:
obtaining a correlation value of each candidate region; and
judging that synchronization has been obtained in a corresponding candidate region if a specific correlation value is greater than a threshold value.

8. An initial synchronization method of a mobile communication system comprising:
accumulating signals I and Q and obtaining an absolute values for each signal;
combining the two absolute values;
estimating a candidate region from a power distribution of the added absolute values; and
correlating the estimated candidate region with a synchronous code to obtain initial synchronization of a terminal.

9. The method of claim 8, wherein the estimating comprises:
searching for a region with a high power distribution from the absolute value of one frame;
checking whether a length of the region with the high power distribution corresponds to a search range; and
estimating a corresponding region as a candidate region if the length of the region with the high power distribution corresponds to the search range.

10. The method of claim 9, wherein the search range is 64 chips.

11. The method of claim 8, wherein to obtain the initial synchronization comprises:
obtaining a correlation value by correlating the candidate region and a synchronous code; and
judging that synchronization has been obtained at the candidate region if the correlation value is greater than a threshold value.

12. An apparatus in a mobile communication system comprising:
first and second accumulation buffers to respectively accumulate I and Q signals;
first and second absolute value calculators to obtain an absolute values from outputs of the first and second accumulation buffers;
an adder to add outputs of the first and second absolute value calculators;
an estimator to estimate a candidate region for initial synchronization from the added absolute value; and
a synchronization searching unit to obtain an initial synchronization of a terminal by correlating the estimated candidate region and a synchronous code.

13. The apparatus of claim 12, wherein the accumulation buffer is a circulation buffer.

14. The apparatus of claim 12, wherein the estimator configured to search a region having a high power distribution from an absolute value of one frame and estimates a region with a length of a power distribution corresponding to the search range as a candidate region.

15. The apparatus of claim 14, wherein the search range is 64 chips.

16. The apparatus of claim 12, wherein the synchronization searching unit is configured to obtain a correlation value by correlating the candidate region and a synchronous code, and if the correlation value is greater than a threshold value, the synchronization searching unit is configured to judge that synchronization has been obtained in the candidate region.

17. The apparatus of claim 12, wherein the apparatus is a base station.

18. The apparatus of claim 12, wherein the apparatus is a mobile terminal.

19. The apparatus of claim 12, wherein the apparatus comprises at least one base station and at least one mobile terminal.

20. The apparatus of claim 12, wherein the communication system is at least one of a Time Division-Synchronous Code Division Multiple Access CM-SCDMA) communication system and a Universal Mobile Telecommunications System-Time division Duplexing (UMTS-TDD) communication system.

21. An apparatus comprising:
an estimator configured to select a region from an input signal, wherein the input signal comprises combined value of I and Q signals;
a synchronization configured to determine an initial synchronization from the region by correlating the selected region to a synchronization code.

22. The apparatus of claim 21, further comprising:
accumulation buffers and absolute value calculators configured to receive the I and Q signals and to generate absolute values for each signal; and
an adder configured to add the absolute values of the I and Q signal to generate the combined value of the I and Q signals and to convey the combined value to the estimator.

23. The apparatus of claim 22, wherein the accumulation buffers are circular buffers.

24. The apparatus of claim 23, wherein the accumulation buffers are configured to accumulate a plurality of oversampled I and Q signals, respectively.

25. The apparatus of claim 21, wherein the estimator is configured to select the region by searching the input signal and selecting a region that has a relatively high power distribution in comparison to the remaining input signal.

26. The apparatus of claim 25, wherein the estimator is configured to select the region by comparing the length of the region to a search range.

27. The apparatus of claim 26, wherein the search range is 64 bits.

28. The apparatus of claim 21, wherein the apparatus is at least one of a base station and a mobile terminal.

29. The apparatus of claim 21, wherein is a mobile communication system.

30. The apparatus of claim 29, wherein the mobile communication system is at least one of a Time Division-Synchronous Code Division Multiple Access (TD-SCDMA) communication system and a Universal Mobile Telecommunications System-Time division Duplexing (UMTS-TDD) communication system.
